(19) United States
(12) Patent Application Publication
(10) Pub. No.: US 2004/0105500 A1
(43) Pub. Date: Jun. 3, 2004

(54) Image processing system

(76) Inventors: Koji Hosogi, Yokohama (JP); Kiyokazu Nishioka, Odawara (JP); Yukio Fujii, Yokohama (JP); Yoshifumi Fujikawa, Sagamihara (JP); Shigeki Higashijima, Machida (JP)

Correspondence Address: MATTINGLY, STANGER & MALUR, P.C., 1800 DIAGONAL ROAD, SUITE 370, ALEXANDRIA, VA, 22314, US

(21) Appl. No.: 10/400,550

(22) Filed: Mar. 28, 2003

(30) Foreign Application Priority Data
Apr. 5, 2002 (JP) 2002-103330

(51) Int. Cl. H04B 1/66; G06T 9/00; H04N 7/12; G06K 9/36

(52) U.S. Cl. 375/240.26; 382/233; 382/236; 375/240.25

(57) ABSTRACT

In a system in which a CPU 2 and a motion compensation coprocessor 1 are interconnected via a bus 3, the motion compensation coprocessor 1 has computation descriptor registers 12 that are chainable on an individual process basis, and comprises means for reading reference data in accordance with the contents of the computation descriptor registers, means for outputting a computation result, a read/storage circuit 18 for storing reference data, a write/storage circuit 19 for storing a computation result, and a motion compensation computing unit 17.

### BACKGROUND OF THE INVENTION

The present invention relates to a processor system having an image processing coprocessor, and more particularly to a technology for performing high-speed image processing at a low cost with a coprocessor. In media processing where a real-time processing capability, that is, an enhanced processing capability, is required, an MPEG LSI having fixed functions or other hard-wired dedicated chip was used. In recent years, however, a software-based approach, which uses a media processor containing a media computing unit, are highlighted. The media processor includes a host of computing units that are specially designed for media processing, and complies with various standards with the aid of software. Therefore, the media processor can be implemented as a single chip that has different functions such as image processing and sound processing functions.

In marked contrast with a hard-wired, dedicated LSI designed for specific media processing, however, the media processor is expected to offer versatility. It is therefore demanded that the media processor deliver enhanced performance. As a result, the media processor generally has to handle high frequencies for processing purposes and entails a high cost.

To solve the above problem, the technology disclosed by Japanese Patent Laid-open No. 10-275135 keeps the required frequencies low by performing distributed processing while using an MPEG decoding coprocessor or other coprocessor in conjunction with a CPU, which performs general-purpose processes.

In an MPEG decoding process, a decoded image is generated by subjecting an entered bitstream to the processes for inverse quantization, inverse discrete cosine transform, and motion compensation on a macroblock-by-macroblock basis. Since the MPEG decoding process is sequentially performed, all the circuits required for inverse quantization, inverse discrete cosine transform, motion compensation, and image generation are implemented in the same manner as for the coprocessor described in Japanese Patent Laid-open No. 10-275135, and the process is performed while making overall process timing adjustments. In addition to the amount of logic required for the general-purpose CPU, the employed coprocessor requires the same amount of logic as the MPEG decoding LSI. This results in an increase in the cost of a processor system for image processing.

### SUMMARY OF THE INVENTION

The system configuration for solving the above problems will now be described. In an image processing system comprising a CPU, an image processing coprocessor, a main storage control circuit, and a main storage connected to the main storage control circuit, the image processing coprocessor stores the information required for each unit of processing in descriptor form. The CPU, image processing coprocessor, and main storage control circuit are interconnected via a bus. The employed descriptor includes at least the information indicating the process performed by the image processing coprocessor, the information indicating the address of an area that stores the data to be referenced by the image processing coprocessor, the information indicating the address of an area to which the computation result generated by the image processing coprocessor is to be output, and the information indicating the address at which the next descriptor is stored. The image processing coprocessor uses the descriptor information, and comprises an address generator for generating an address for accessing the data to be referenced by the image processing coprocessor, an address generator for generating the address for outputting the computation result generated by the image processing coprocessor, an address generator for generating the address for reading the next descriptor, and a selector for selecting the above addresses. Further, the image processing coprocessor reads the next descriptor and automatically performs image processing for the next unit of processing.

Furthermore, the image processing coprocessor transfers data to the bus in accordance with the addresses generated by the address generators, includes a computing unit, which operates in accordance with the reference data and the information describing the process, and outputs the computation result to the bus.

### BRIEF DESCRIPTION OF THE DRAWINGS

FIG. 1 is a block diagram illustrating a first embodiment;

FIG. 2 is a schematic diagram illustrating a motion compensation process;

FIG. 3 shows an example of a computation descriptor register 12;

FIG. 4 shows an example of an output descriptor register 13;

FIG. 5 shows an example of control information 11;

FIG. 6 shows a description example of a computation descriptor;

FIG. 7 shows an example of an address generator 14;

FIG. 8 shows an example of a reference address generator 140;

FIG. 9 shows an example of an output address generator 142;

FIG. 10 shows an example of a descriptor address generator 144;

FIG. 11 is a block diagram illustrating a second embodiment;

FIG. 12 shows an example of a read/storage circuit 18 according to the second embodiment; and

FIG. 13 shows an example of a motion compensation computing unit.

### DETAILED DESCRIPTION OF THE PREFERRED EMBODIMENTS

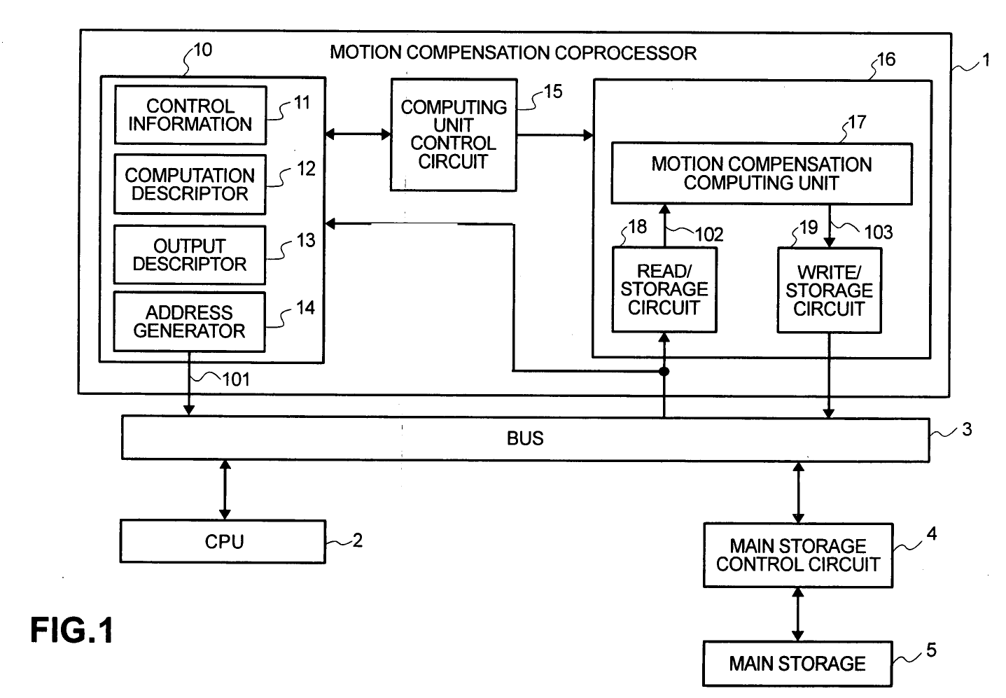

A first embodiment will now be described with reference to FIG. 1. FIG. 1 is a block diagram that illustrates the configuration of an image processing system according to the present embodiment.

In the image processing system, a CPU 2 for performing general-purpose computations and media computations, a motion compensation coprocessor 1 for performing a motion compensation process, and a main storage control circuit 4 are interconnected via a bus 3. The main storage control circuit 4 is connected to a main storage 5 such as an SDRAM or RDRAM.

An MPEG decoding process is performed for both the luminance component and color difference component. For the description of the present embodiment, however, only the luminance component is dealt with. The decoding process for the color difference component is performed in the same manner as for the luminance component because the same processing sequence is followed in spite of the difference in the image size. Although the description of the present embodiment deals with an image processing coprocessor that is specially designed for motion compensation, the present invention is also applicable to the other image processing coprocessors.

The motion compensation coprocessor 1 is a coprocessor that compensates for the motion in the MPEG process. This coprocessor includes a motion compensation computation section 16, which comprises a read/storage circuit 18 for storing the data to be referenced at the time of motion compensation computation, a motion compensation computing unit 17 for performing motion compensation computations, and a write/storage circuit 19 for storing the computation result generated by the motion compensation computing unit 17; an address generation section 10, which comprises control information 11, which is a group of registers that can be read and written into by software, a computation descriptor register 12, an output descriptor register, and an address generator 14 for generating the address for accessing data in accordance with the contents of the above registers and transferring the address to the bus 3; and a computing unit control circuit 15, which generates a control signal for controlling the motion compensation computation section 16 in accordance with the contents of the control information 11, computation descriptor register 12, and output descriptor register 13.

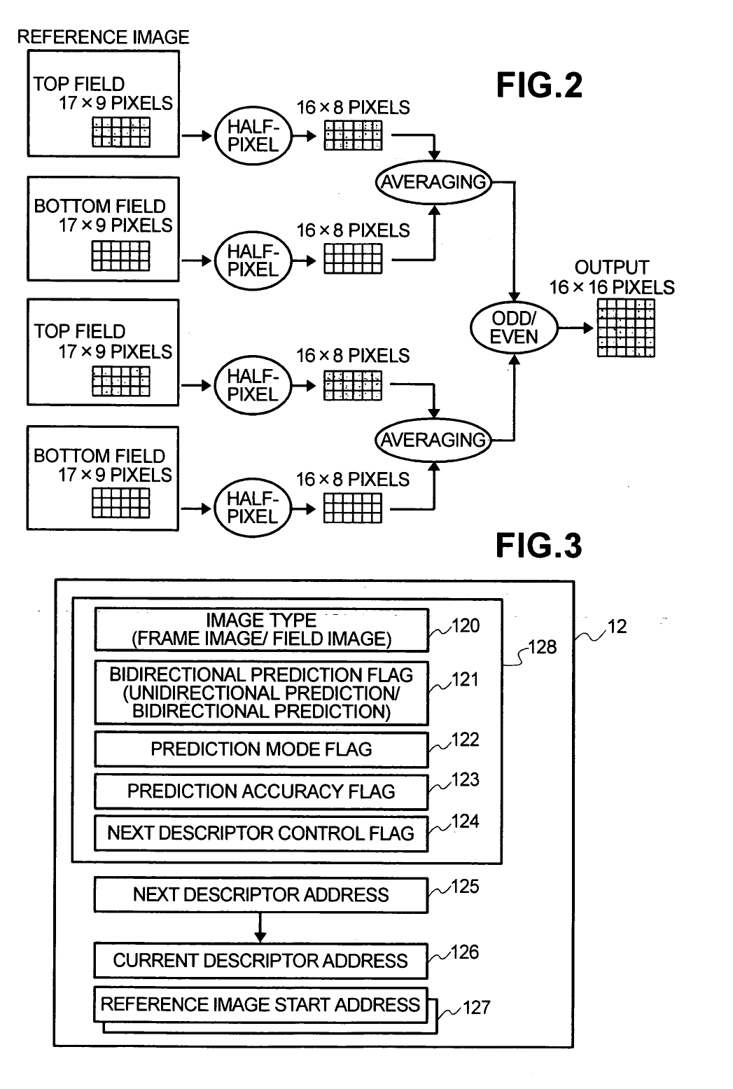

The motion compensation process will now be outlined with reference to FIG. 2. FIG. 2 illustrates a dual prime prediction method for frame images, which is one of a variety of motion compensation processes. This motion compensation process is performed on the basis of four reference images consisting of 17×9 pixels. In this process, neighboring pixels are subjected to averaging with rounding in the unit of a half-pixel to generate an image consisting of 16×16 pixels. Therefore, the motion compensation coprocessor 1 reads the reference images in accordance with the address of an area that stores the reference images and the information about a frame image and dual prime prediction or other motion compensation process, subjects the read images to averaging with rounding, generates a 16×16 pixel image, and performs a process for outputting the generated image. The present embodiment will now be described in detail.

First of all, the computation descriptor register 12, which is shown in FIG. 1, will be described in detail in FIG. 3.

The computation descriptor register 12 is a group of registers that mainly store the information necessary for motion compensation processing of each macroblock. These registers store the information about an image type 120 for indicating whether the image to be subjected to motion compensation is a frame image or field image, a bidirectional prediction flag 121 for indicating whether the prediction is unidirectional or bidirectional, a prediction mode flag 122 for indicating the prediction mode for the image to be decoded (frame prediction, field prediction, dual prime prediction, MPEG2 16×MC prediction, MPEG4 4MV prediction, etc.), a prediction accuracy flag 123 for indicating the half-pixel accuracy, one-fourth pixel accuracy, or other macroblock motion vector pixel accuracy, a next descriptor control flag 124 for indicating whether the next descriptor needs to be read, a next descriptor address 125 for indicating the start address of an area in which the next computation descriptor is stored, a current descriptor address 126 for indicating the address at which the current computation descriptor is stored, and a reference image start address 127 for indicating the address at which the past/future reference image data to be referenced by the motion compensation process is stored.

The contents of the register storing the next descriptor address 125 are to be copied to the register for storing the current descriptor address 126. When the next computation descriptor is read by the group of registers, the register for storing the current descriptor address 126 is updated to the value registered as the next descriptor address 125. The image type 120, bidirectional prediction flag 121, prediction mode flag 122, prediction accuracy flag 123, and next descriptor control flag 124 are collectively referred to as descriptor control information 128.

The reference image start address 127 may alternatively be handled by a plurality of registers. The reason is that a plurality of image data may be referenced depending on the prediction mode for the motion compensation process. When, for instance, a frame image is handled in the unidirectional frame prediction mode, one area is referenced. Two areas are referenced when a frame image is handled in the bidirectional frame prediction mode. In the MPEG4 4MV bidirectional prediction mode, the number of areas to be referenced is maximized to 8. Therefore, when the address generation section 10 has registers for storing up to eight reference image start addresses 127, all reference areas needed for various image processes can be covered. In consideration of the area cost, however, the present embodiment deals with a case where two registers are used to store two sets of reference image start addresses 127.

For the motion compensation process concerning MPEG2 or MPEG4, the computation method is determined according to the image type 120, bidirectional prediction flag 121, prediction mode flag 122, and prediction accuracy flag 123, which are among the descriptor control information 128 stored in the computation descriptor register 12 shown in FIG. 3. The computing unit control circuit 15 reads the descriptor control information 128 prior to motion compensation processing of each macroblock, and controls the motion compensation circuit 17 in accordance with the read information. The motion compensation circuit 17 performs computations by the method determined according to the control of the computing unit control circuit 15 in order to provide macroblock motion compensation.

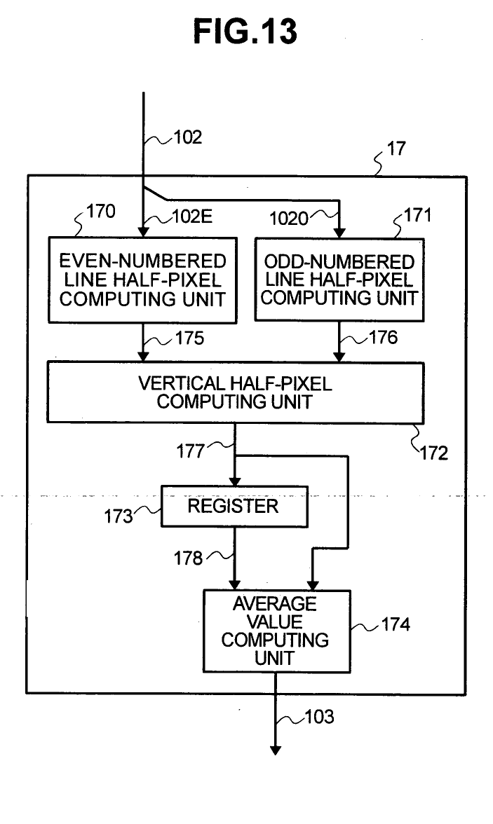

The motion compensation computing unit 17 according to the present embodiment will now be described in detail with reference to FIG. 13.

The present embodiment is configured so as to simultaneously read two lines (even- and odd-numbered lines) of reference data 102 from the read/storage circuit 18. An even-numbered line half-pixel computing unit 170 computes the even-numbered line horizontal half-pixel value 175 in accordance with even-numbered line reference data 102E. An odd-numbered line half-pixel computing unit 171 computes the odd-numbered line horizontal half-pixel value 176 in accordance with odd-numbered line reference data 1020. The computation results 175, 176 produced by the half-pixel computing units are entered into the vertical half-pixel computing unit 172. The vertical half-pixel computing unit 172 calculates the rounded average 177 of a total of four vertical/horizontal pixels in accordance with the entered data.

When the prediction accuracy flag 123 stored in the computation descriptor register 12 indicates that half-pixel value calculations are not needed, the motion compensation computing unit 17 masks the even-numbered line reference data 102E, odd-numbered line reference data 1020, even-numbered line horizontal half-pixel value 175, and odd-numbered line horizontal half-pixel value 176, which are entered into the respective computing units, and provides a shifter for the output of each computing unit to inhibit half-pixel value calculations.

In the dual prime prediction mode and bidirectional prediction mode, a pipeline process is performed so that an average value computing unit 174 averages the two rounded average 4-pixel values 177. More specifically, the rounded average 4-pixel value 178, which is derived from the rounded average 4-pixel value 177 stored in register 173, and the corresponding pixel rounded average value 177 are entered into the average value computing unit 174. The average value computing unit 174 outputs a final rounded average 4-pixel value 103 to a write circuit 19. When no average value computation is required within the average value computing unit 174, the computations can be masked with a mask and shifter in the average value computing unit 174.

In the above MPEG motion compensation computations, the final rounded average 4-pixel value 103 can be obtained by controlling the input sequence for the reference data 102 to be entered and the output sequence for the final rounded average 4-pixel value 103 to be output. These sequences are determined by the values of the image type 120, bidirectional prediction flag 121, prediction mode flag 122, and prediction accuracy flag 123, which are contained in the descriptor control information 128. The computing unit control circuit 15 reads these items of information contained in the descriptor control information 128, and controls the read pointer for the read/storage circuit 18 and the write pointer for the write/storage circuit 19.

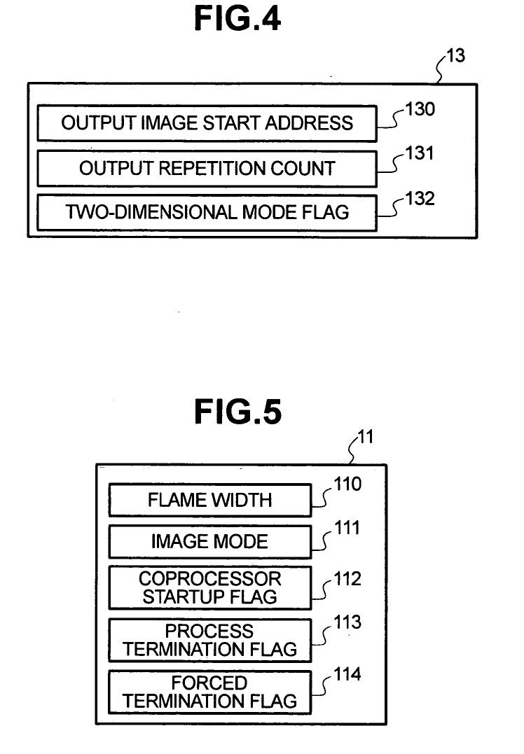

The output descriptor register 13 shown in FIG. 1 will now be described in detail with reference to FIG. 4.

In a general MPEG image decoding process, processing steps are sequentially performed on a macroblock-by-macroblock basis. The direction of processing succession is horizontal. In the motion compensation processing steps that are sequentially performed on a macroblock-by-macroblock basis, therefore, the address of the location for storing the computation result produced by the motion compensation coprocessor 1 is not randomly generated but can easily be hardware-predicted in accordance with the frame width and other relevant information. Although the description of the present embodiment deals with a method that can easily be implemented, the present invention is not limited to the present embodiment.

The output descriptor register 13 is a group of registers, which store the information necessary for computation result storage. This register 13 stores an output image start address 130, which indicates the start address of an area for storing the computation result produced by the motion compensation coprocessor 1, and an output repetition count 131, which indicates the number of macroblocks to be output, that is, the number of times the process is repeated to complete the entire image process. Each macroblock has 16×16 pixels. Consequently, the initial motion compensation computation result is generated as the computation result of one macroblock by outputting the computation result of the next line to the address that is offset by 16 pixels plus the frame width from the output image start address 130 and repeating this computation result output operation for 16 lines. The new output image start address for the next macroblock is determined by adding a 16-pixel address value to the output image start address 130.

The computation result produced by the motion compensation computation section 16 is then added to the result of an inverse discrete cosine transform to generate a final decoded image. Therefore, this computation result need not be two-dimensionally arrayed like a pictorial image. A two-dimensional mode flag 132 is used to specify whether the computation result is to be output in a continuous one-dimensional array or two-dimensionally.

The control information 11 shown in FIG. 1 will now be described in detail with reference to FIG. 5.

The control information 11 is a group of registers, which mainly store the information that does not vary during a single-frame motion compensation processing sequence and the information about a flag that indicates the startup and operation status of the motion compensation coprocessor 1. These registers respectively store the information about a frame width 110, which is a field indicating the frame width of the image to be decoded; an image mode 111, which indicates the MPEG2/MPEG4 half sample mode or quarter sample mode, the studio profile mode for indicating the bit depth per pixel (8 bits wide in the standard mode or 12 bits wide in the studio profile mode), or other image mode; a coprocessor startup flag 112 for starting the motion compensation coprocessor 1; a process termination flag 113 that is automatically reset when the motion compensation process for a macroblock is completed to transfer generated data to the bus 3; and a forced termination flag 114 for specifying a forced termination of the process of the motion compensation coprocessor 1. The process termination flag 113 is used for polling the motion compensation coprocessor 1 with the CPU 2 for synchronization purposes.

The description of the above registers is given for explanation purposes. The present invention is not limited to the present embodiment.

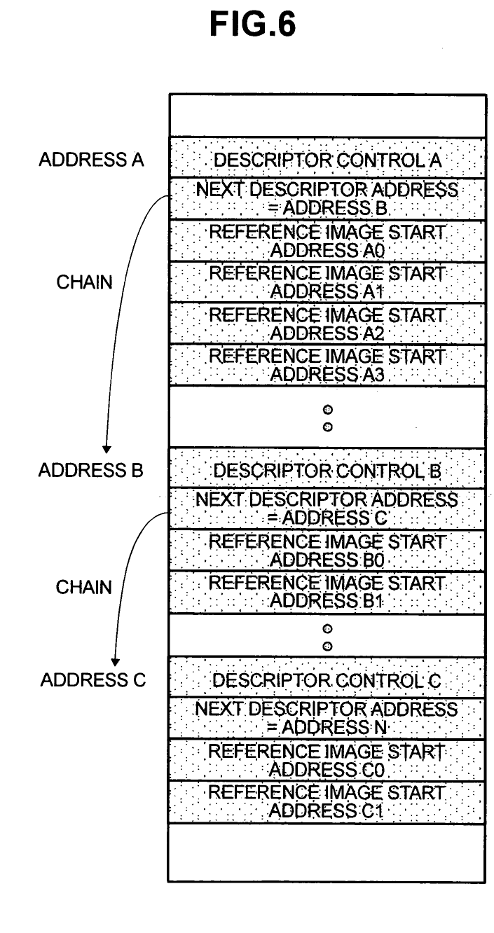

FIG. 6 shows a description example of a computation descriptor. The computation descriptor is generated by the CPU 2 and stored in the main storage 5 or a data cache in the CPU 2.

The computation descriptor is a data stream in which descriptor control information, next descriptor address, and a plurality of reference image start addresses are successively written. This data stream is arrayed in the same form as for the computation descriptor register 12. The motion compensation coprocessor 1 first loads the computation descriptor into the computation descriptor register 12 and then performs a motion compensation process in accordance with the loaded information. When the motion compensation process for one macroblock is terminated in situations where the next descriptor control flag 124 indicates the necessity of reading the next descriptor and the forced termination flag 114 is set so as not to cause a forced termination, the motion compensation coprocessor 1 reads the next computation descriptor from the next descriptor address 125 (address b) and updates the contents of the computation descriptor register 12. If the forced termination flag 114 is set so as to cause a forced termination, the motion compensation coprocessor 1 does not read the next computation descriptor. Therefore, the motion compensation coprocessor 1 can successively perform a repercussive motion compensation process for each macroblock in accordance with the information derived from the address generation section 10.

Even if the computation descriptor is stored in the main storage 5 or the data cache in the CPU 2, the motion compensation coprocessor 1 can read the correct computation descriptor under general snoop control. Meanwhile, the CPU 2 simply has to write the generated computation descriptor into a memory area by performing either a cacheable write or noncacheable write.

Since the motion compensation coprocessor 1 performs a motion compensation process in accordance with a computation descriptor chain as described above, task switching can be flexibly effected by defining the computation descriptor for another image as the computation descriptor's chain destination. Further, when a register for storing the information indicating whether the current image is a luminance component or color difference component is provided within the computation descriptor register 12, the size of reference data and computation result data can be determined in accordance with the stored information. As a result, the motion compensation processes for the luminance component and color difference component can be performed by a single unit of the motion compensation coprocessor 1. When two processes are performed by a single unit of the motion compensation coprocessor 1, however, the required number of cycles increases. Consequently, the operating frequency of the motion compensation coprocessor must be substantially raised in order to perform a real-time decoding process. With this taken into consideration, a plurality of units of the motion compensation coprocessor 1 can be furnished to assign one unit to the luminance component and one or more remaining units to the color difference component. As a result, the operating frequency can be kept low.

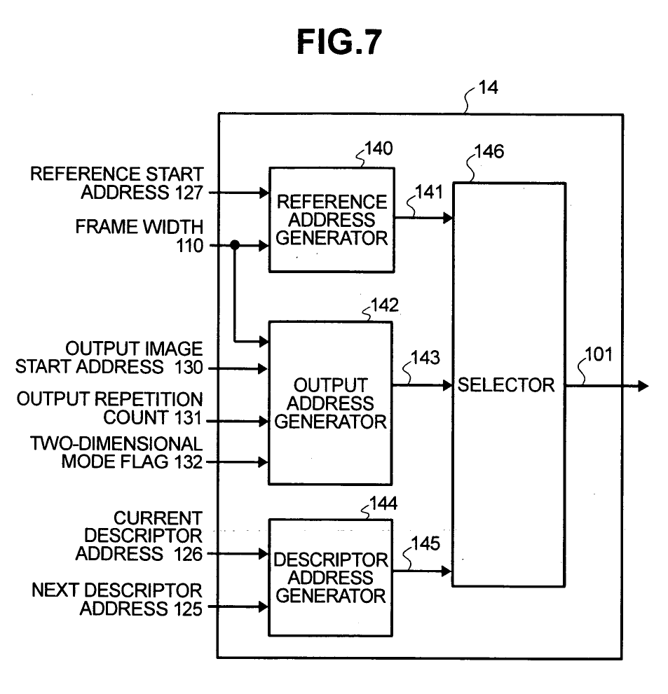

The address generator 14 shown in FIG. 1 will now be described in detail with reference to FIG. 7.

In accordance with the contents of the control information 11, computation descriptor register 12, and output descriptor register 13, the address generator 14 generates the address of a data area to be accessed by the motion compensation coprocessor 1. As indicated in the example of a motion compensation process in FIG. 2, the motion compensation process reads two-dimensional reference image data, performs various processes including the process for averaging with rounding, and outputs the produced computation result. To support this motion compensation process, the address generator 14 comprises a reference address generator 140 for generating a reference address 141 for use in reference image reading, an output address generator 142 for generating an output address 143, a descriptor address generator 144 for generating a descriptor address 145, and a selector 146 for selecting one access address 101 out of the addresses generated by the above address generators. The access address 101 is transferred to the bus 3. Further, the address generator 14 has a bus protocol and communicates with the main storage 5, CPU 2, and other agents connected to the bus 3.

The individual address generators, which are contained in the address generator 140, will now be described.

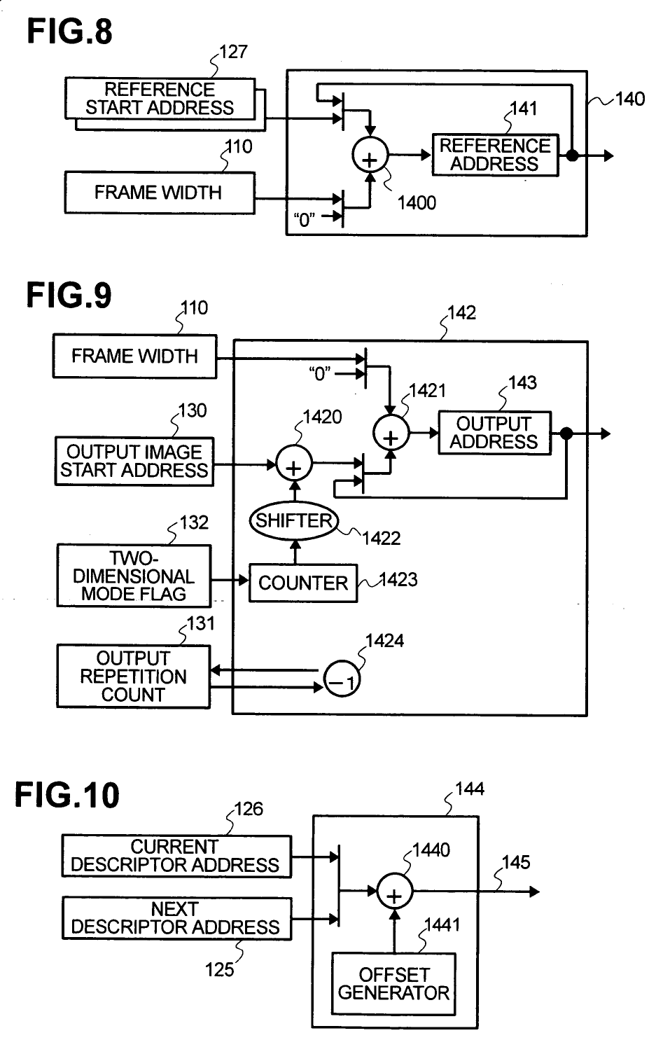

FIG. 8 is a block diagram illustrating an example of the reference address generator 140. Since the reference image has a two-dimensional data structure, the reference address 141, which is the address for reading the reference image, has a two-dimensional structure. Therefore, the reference address 141 consists of a plurality of addresses. The first reference address 141 serves as a reference image start address 127. Therefore, the reference image start address 127 and the value “0” are entered into an adder 1400 to generate a reference address 141. The next reference address 141 is the address of the next line, that is, the sum of the previous reference address 141 and a frame width 110. Consequently, the previous reference address 141 and the frame width 110 are entered into the adder 1400 to generate the next reference address 141. The reference address generator 140 repeats this sequence to generate a two-dimensional reference address 141.

If, for instance, the frame image shown in FIG. 2 is handled in the dual prime prediction mode, the size of a reference image is 17×9 pixels, that is, equivalent to 9 lines. Therefore, the above address generation process is performed 9 times. Further, when the frame image shown in FIG. 2 is handled in the dual prime prediction mode, a total of 4 reference images are required. Therefore, when a reference image is completely read, the next reference image start address 127 is handled as a new reference address 141, and this is also repeated to cover 9 lines to generate a reference address 141. When two or more reference images are used in the present embodiment, the address generation section 10 overwrites a new reference image start address 127 in the register containing a reference image start address 127 that is no longer needed. This feature reduces the number of registers used with the motion compensation coprocessor 1. The read and generation of the new reference image start address will be described when the descriptor address generator 144 is described later.

The reference address 141 is used when the motion compensation coprocessor 1 reads reference image data from the main storage 5 or the like, and output to the bus 3 via the selector 146. In accordance with the reference address 141 that is output to the bus 3, the main storage 5 or CPU 2 outputs reference image data to the bus 3. The reference image data is transferred to the read/storage circuit 18 via the bus 3. The motion compensation computing unit 17 performs motion compensation computations in accordance with the data read by the read/storage circuit 18.

The output address generator 142 will now be described with reference to FIG. 9.

As is the case with the reference address 141, the output address 143 has a two-dimensional structure. Therefore, the output address generator 142 can obtain an output address 143 by adding the output image start address 130 to the frame width 110 with an adder 1421 in the same manner as the reference address generator 140. Although the reference image storage location address is randomly generated, the output address 143 can easily be predicted by hardware when the individual macroblock processing steps for a fixed MPEG decoding process are followed. With this taken into consideration, an example of hardware prediction of the output address 143, in which a counter 1423 is used for the output address generator 142 according to the present embodiment will now be described.

When processing is conducted on a macroblock-by-macroblock basis, the next macroblock is positioned to the preceding macroblock's immediate right except for the rightmost end of the frame. Therefore, the output address 143 for the second macroblock is determined by shifting the preceding output image start address 130 by 16 pixels. Consequently, the output address 143 for the second macroblock can be calculated with an adder 1420 by adding a 16-pixel address value, which is generated via a shifter 1422, to the output image start address 130. In like manner, the output address 143 for the third macroblock can be calculated with the adder 1420 by adding an address value that is equivalent to two sets of 16 pixels. To invoke a 16-pixel shift, the address generation section 10 increments the counter 1423 when the motion compensation process is completed for one macroblock. As a result, the value registered in the shifter 1422 changes so as to add an address value, which is shifted by 16 pixels, to the output image start address 130.

For synchronization purposes, the CPU 2 needs to recognize the macroblocks that have been subjected to motion compensation processing. To provide such synchronization, the output address generator 142 changes the value of a decrementer 1424 in synchronism with the update of the counter 1423. In accordance with the value of the decrementer 1424, the address generation section 10 decrements an output repetition count 131. The CPU 2 achieves synchronization by reading the output repetition count 131.

The computation result generated by the motion compensation coprocessor 1 need not have the same two-dimensional array structure as image data because it is merely added to the data derived from an inverse discrete cosine transform in the CPU 2. Meanwhile, when data having a two-dimensional array structure is to be stored in the data cache in the CPU 2, data cache thrashing may occur due to the data's orderly arrangement, thereby deteriorating the performance. Therefore, if a one-dimensional value is stored in a register for storing the two-dimensional mode flag 132, the output address generator 142 controls the counter 1424 so that the output addresses 143 are consecutive. More specifically, the output address generator 142 uses the value “0”, in replacement of the frame width 110, for the input of the adder 1421 to generate consecutive addresses.

The output address 143 is used by the motion compensation coprocessor 1 when data is to be output from the write/storage circuit 19 to the bus 3. This address is transferred to the bus 3 via the selector 146. Subsequently, the motion compensation coprocessor 1 outputs the associated data from the write/storage circuit 19 to the bus 3 in compliance with the bus protocol.

The descriptor address generator 144 will now be described with reference to FIG. 10.

The reference address generator 140 is described earlier so that a new reference image start address is read in order to reduce the number of set reference image start addresses 127. The reference image start addresses are consecutively arrayed as is the case with the computation descriptor's description example shown in FIG. 6. Therefore, when a new reference image start address 127 is to be read, the address generation section 10 uses a descriptor address 145, which is generated with an adder 1440 by adding a current descriptor address 126 and an offset generated by an offset generator 1441. The descriptor address 145 generated by the descriptor address generator 144 is output to the bus 3 via the selector 146. As a result, the address generation section 10 reads the next reference image start address 127, which is output to the bus 3, and updates the contents of a register for storing the reference image start address 127 in compliance with the bus protocol.

When the next computation descriptor is to be read upon completion of a process that is performed by the computation descriptor for one macroblock, the address generation section 10 may add, with the adder 1440, the current descriptor address 126 to an offset, which is generated by the offset generator 1441 in accordance with the capacity of the computation descriptor, and use the address derived from the addition as the next descriptor address 145 instead of using the next descriptor address 125 stored in the computation descriptor register 12. The calculated descriptor address 145 is output to the bus 3 via the selector 146. In compliance with the bus protocol, the memory 5 or CPU 2 outputs to the bus 3 the computation descriptor corresponding to the descriptor address 145 that is output to the bus 3. The address generation section 10 reads the computation descriptor that is output to the bus 3 in compliance with the bus protocol, and updates the contents of the computation descriptor register 12 to the read data. The motion compensation computation section 16 then performs a motion compensation process for the next macroblock in accordance with the value of the computation descriptor register 12. This prevents the computation descriptor from containing the information about the next descriptor, thereby reducing the amount of information.

As described above, the motion compensation coprocessor 1 uses the computation descriptor 12 to perform a motion compensation process on a macroblock-by-macroblock basis.

The description of the present embodiment has been centered on a motion compensation process. In an MPEG decoding process, however, the data derived from an inverse discrete cosine transform is added to the data derived from a motion compensation process after completion of the motion compensation process to generate a final decoded image data. Therefore, when a descriptor containing the start address of a storage area for the inverse discrete cosine transform result is written into the computation descriptor register 12 in the same format as for the reference image start address 127, the coprocessor can operate to perform an image generation process as well as a motion compensation process.

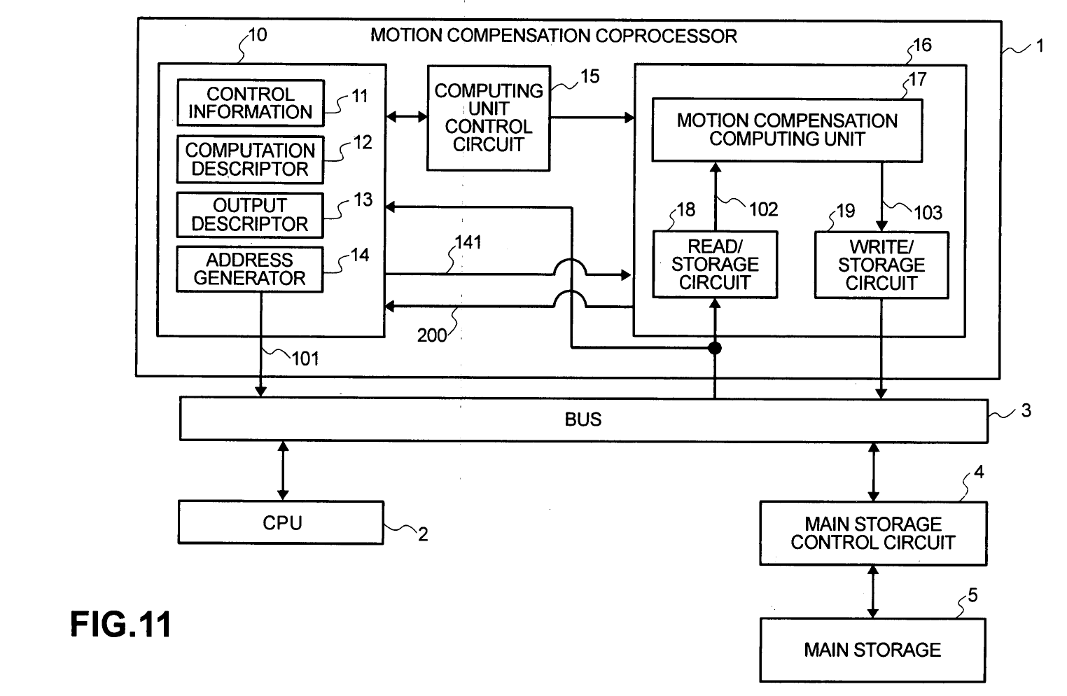

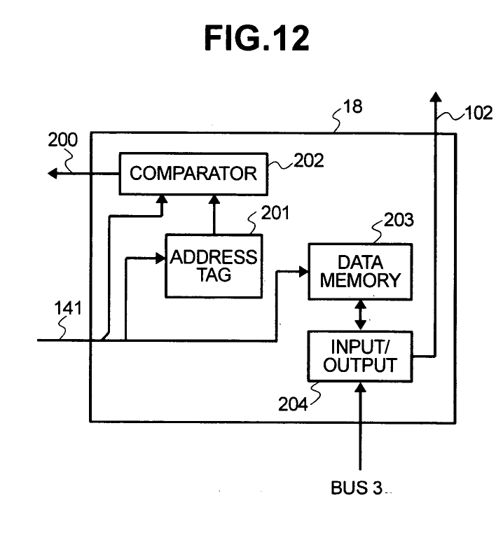

A second embodiment will now be described with reference to FIGS. 11 and 12.

The present embodiment differs from the embodiment shown in FIG. 1 in that the former enters the reference address 141 generated by the reference address generator 140 into the read/storage circuit 18 of the motion compensation computation section 16 without via the bus 3, and includes a read/storage circuit 18 that comprises a cache memory having a general address tag 201 and a data memory 203.

The read/storage circuit 18 uses a comparator 202 to compare the entered reference address 141 against the address value stored in the address tag 201, and outputs the result to signal line 200. When the information output to signal line 200 indicates that the compared addresses match, the motion compensation computing unit 17 reads the reference data 102 indicated by the address tag from the data memory 203 and performs motion compensation computations. If the information output to signal line 200 indicates that the compared addresses do not match, the motion compensation computation section 16 issues a reference image read process to the bus 3. In compliance with the bus protocol, the motion compensation computation section 16 then reads the reference image data, which is output to the bus 3, and writes the read data into the data memory 203 while at the same time updating the address tag 201. Even if the reference image size is 17×17 pixels in this instance, the cache memory is effectively used on the presumption that the size of data to be read is larger than the size of the data including the reference image. The use of this method introduces performance improvements, which will now be described.

In a motion compensation process in which processing steps are sequentially performed in a horizontal direction for each macroblock, it is likely that the reference image to be referenced next is positioned at an address next to that of the reference image used for the previous motion compensation process. The reason is that when the entire frame is shifted, a frame shift also occurs in an MPEG encoding process in the same manner. Further, the maximum size of the reference image for a motion compensation process is 17×17 pixels. The start address of this reference image is randomly generated and the address offset is not constant. In general, the throughput performance of the main storage 5 such as an SDRAM and the bus 3 is higher in burst access than in single access. The main storage control circuit 4 and the bus protocol for and the bus 3 are implemented so as to provide an enhanced burst transfer rate.

Therefore, even if the data that may be used for the motion compensation process for the next macroblock is read when the first reference image is read in the embodiment shown in FIG. 1, the data is once discarded and the same data is read again at the time of motion compensation processing for the next macroblock. As a result, the load on the bus 3 increases, making it difficult to improve the performance.

Therefore, when the read/storage circuit 18 reads extra reference data and stores it in the cache memory beforehand in accordance with the second embodiment, the probability of reference data storage in the cache memory increases. As a result, the read latency decreases, thereby reducing the time required for a reference data read.

The foregoing two embodiments have been described with special reference to an MPEG motion compensation coprocessor. However, when the present invention is applied, a part of a process required for various applications can be turned into a coprocessor, which can perform specific processes in accordance with the information that is generated by the CPU to describe the process performed for computing unit operation, the address indicating the area of the data to be referenced on an individual process basis, the address indicating the area for computation result output, and the descriptor containing the information necessary for an individual process. Further, the descriptor contains the address of the area in which the next descriptor is stored. The coprocessor includes an address generator for generating an address in accordance with the above information. When a specified unit of processing terminates, the coprocessor reads the next descriptor in accordance with the address generated by the address generator.

Further, the coprocessor includes a read/storage circuit for storing read reference data, a computing unit for performing computations on the read reference data and process description information, and a write/storage circuit for storing the computation result produced by the computing unit. In accordance with the address indicating the area for computation result output, the write/storage circuit outputs the computation result. With the configuration described above, it is possible to perform the above process for motion compensation and all other computing operations, thereby improving the processing capability of the image processing system.

The above embodiments enable a coprocessor having a small area to perform a motion compensation process and introduce performance improvements. The performance can be further improved by using the cache memory in accordance with the second embodiment.

Further, when a descriptor chain is used in accordance with the above embodiments, coprocessor startup can be achieved for each macroblock process. The use of a single coprocessor is then adequate for handling a plurality of bitstreams without sacrificing the performance, thereby avoiding performance deterioration, which may otherwise result from the use of a task switch.

Furthermore, when an MPEG decoding process is performed in accordance with the above embodiments, it is possible to use a coprocessor as a motion compensation circuit, which entails considerable amounts of computation and data transfer, while allowing the CPU to perform the other processes that entail a small amount of computation. As a result, the amount of logic can be decreased to reduce the cost.

What is claimed is:

1. An image processing system, comprising:
a CPU;
a coprocessor:
a main storage control circuit;
a bus for interconnecting said CPU, said coprocessor, and said main storage control circuit; and
and a main storage connected to said main storage control circuit,
wherein said CPU creates a descriptor, which includes the information describing the process used for operating said coprocessor, the address indicating the area of the data to be referenced for an individual unit of processing, the address indicating the area for computation result output, and the information necessary for each unit of processing, and stores the created descriptor in said main storage; and
wherein said coprocessor reads said descriptor, reads data from said main storage in accordance with the information stored in said descriptor, and performs a computation process.

2. The image processing system according to claim 1, wherein said coprocessor includes an address generation section and a computation processing section,
wherein said address generation section includes an address generator for generating an address in accordance with the information contained in a register storing said descriptor and the information contained in said descriptor,
wherein said computation processing section includes a read/storage circuit for reading data, a computing unit for performing computations on read said data and the information describing a process, and a write/storage circuit for storing the computation result produced by said, computing unit, and
wherein said computation processing section loads said data into said read/storage circuit in accordance with the address generated by said address generator, and causes said write/storage circuit to output the computation result, which is generated by said address generator, in accordance with the address indicating the area for computation result output.

3. The image processing system according to claim 2, wherein said descriptor includes the address of a storage area for the descriptor that said coprocessor uses during the next computation process, and
wherein said address generator uses the address of the storage area for the descriptor for use in said next computation process to load said descriptor into said register.

4. The image processing system according to claim 3, wherein said coprocessor performs a motion compensation process during an MPEG decoding process.

5. The image processing system according to claim 4, wherein said data corresponds to a reference image for use in said motion compensation process.

6. The image processing system according to claim 5, wherein said coprocessor performs said motion compensation process on a luminance component and color difference component in accordance with said descriptor.

7. The image processing system according to claim 6, comprising a plurality of units of said coprocessor, wherein a luminance component motion compensation process and color difference component motion compensation process are assigned variously to all units of said coprocessor and performed independently of each other.

8. The image processing system according to claim 2, wherein said coprocessor performs a process for adding up the results of a discrete cosine transform process and motion compensation process during an MPEG decoding process.

9. The image processing system according to claim 2, wherein said read/storage circuit includes a cache memory and stores the data subsequent to said data in the cache memory when said data is read.
